(19) United States
(12) Patent Application Publication
(10) Pub. No.: US 2017/0324959 A1
(43) Pub. Date: Nov. 9, 2017

(54) METHOD AND APPARATUS FOR ENCODING/DECODING A HIGH DYNAMIC RANGE PICTURE INTO A CODED BITSTREAM

(71) Applicant: THOMSON LICENSING, Issy les Moulineaux (FR)

(72) Inventors: Yannick OLIVIER, Thorigne Fouillard (FR); Francois CELLIER, Rennes (FR); Christophe CHEVANCE, Brece (FR); David TOUZE, RENNES (FR); Edouard FRANCOIS, Bourg des Comptes (FR)

(21) Appl. No.: 15/582,678

(22) Filed: Apr. 29, 2017

(30) Foreign Application Priority Data
May 4, 2016 (EP) 16305527.0
May 4, 2016 (EP) 16305529.6

(51) Int. Cl. H04N 19/136; G06T 5/00; H04N 19/44

(52) U.S. Cl. CPC H04N 19/136; H04N 19/44; G06T 5/007

(57) ABSTRACT

A method and an apparatus for coding at least one high dynamic range picture into a coded bitstream, and corresponding decoding method and apparatus are disclosed. The encoding method includes selecting a predetermined post-processing color correction function bₚ_{_}_{det} among a set of predetermined post-processing color correction functions bₚ^{set}, according to at least one parameter computed from at least said high dynamic range picture, determining a pre-processing color correction function b₀ from the selected predetermined post-processing color correction function bₚ_{_}_{det}, decomposing the high dynamic range picture, into a standard dynamic range picture, using the pre-processing color correction function b₀, coding the standard dynamic range picture into the coded bitstream, coding at least one parameter for reconstructing the high dynamic range picture from the standard dynamic range picture decoded from the coded bitstream and a post-processing color correction function bₚ_{_}_{dec}.

### 1. REFERENCE TO RELATED EUROPEAN APPLICATIONS

This application claims priority from European Patent Application No. 16305529.6, entitled “METHOD AND APPARATUS FOR ENCODING/DECODING A HIGH DYNAMIC RANGE PICTURE INTO A CODED BITSTREAM”, filed on May 4, 2016 and European Patent Application No. 16305527.0, entitled “METHOD AND APPARATUS FOR ENCODING/DECODING A HIGH DYNAMIC RANGE PICTURE INTO A CODED BITSTREAM”, filed on May 4, 2016, the contents of which are hereby incorporated by reference in their entirety.

### 2. TECHNICAL FIELD

The present disclosure generally relates to picture/video encoding and decoding. Particularly, but not exclusively, the technical field of the present disclosure is related to encoding/decoding of a picture whose pixels values belong to a high-dynamic range.

### 3. BACKGROUND ART

In the following, a color picture contains several arrays of samples (pixel values) in a specific picture/video format which specifies all information relative to the pixel values of a picture (or a video) and all information which may be used by a display and/or any other device to visualize and/or decode a picture (or video) for example. A color picture comprises at least one component, in the shape of a first array of samples, usually a luma (or luminance) component, and at least one another component, in the shape of at least one other array of samples. Or, equivalently, the same information may also be represented by a set of arrays of color samples (color components), such as the traditional tri-chromatic RGB representation.

A pixel value is represented by a vector of c values, where c is the number of components. Each value of a vector is represented with a number of bits which defines a maximal dynamic range of the pixel values.

Standard-Dynamic-Range pictures (SDR pictures) are color pictures whose luminance values are represented with a limited dynamic usually measured in power of two or f-stops. SDR pictures have a dynamic around 10 fstops, i.e. a ratio 1000 between the brightest pixels and the darkest pixels in the linear domain, and are coded with a limited number of bits (most often 8 or 10 in HDTV (High Definition Television systems) and UHDTV (Ultra-High Definition Television systems) in a non-linear domain, for instance by using the ITU-R BT.709 OETF (Optico-Electrical-Transfer-Function) (Rec. ITU-R BT.709-5, April 2002) or ITU-R BT.2020 OETF (Rec. ITU-R BT.2020-1, June 2014) to reduce the dynamic. This limited non-linear representation does not allow correct rendering of small signal variations, in particular in dark and bright luminance ranges. In High-Dynamic-Range pictures (HDR pictures), the signal dynamic is much higher (up to 20 f-stops, a ratio one million between the brightest pixels and the darkest pixels) and a new non-linear representation is needed in order to maintain a high accuracy of the signal over its entire range. In HDR pictures, raw data are usually represented in floating-point format (either 32-bit or 16-bit for each component, namely float or half-float), the most popular format being openEXR half-float format (16-bit per RGB component, i.e. 48 bits per pixel) or in integers with a long representation, typically at least 16 bits.

A color gamut is a certain complete set of colors. The most common usage refers to a set of colors which can be accurately represented in a given circumstance, such as within a given color space or by a certain output device.

A color gamut is sometimes defined by RGB primaries and a white point provided in the CIE1931 color space chromaticity diagram, as illustrated in FIG. 10.

It is common to define primaries in the so-called CIE1931 color space chromaticity diagram. This is a two dimensional diagram (x,y) defining the colors independently on the luminance component. Any color XYZ is then projected in this diagram thanks to the transform:

$$\{ \begin{matrix}x = \frac{X}{X + Y + Z} \\ y = \frac{Y}{X + Y + Z}\end{matrix}$$

The z=1-x-y component is also defined but carries no extra information.

A gamut is defined in this diagram by a triangle whose vertices are the set of (x,y) coordinates of the three primaries RGB. The white point W is another given (x,y) point belonging to the triangle, usually close to the triangle center. For example, W can be defined as the center of the triangle.

A color volume is defined by a color space and a dynamic range of the values represented in said color space.

For example, a color gamut is defined by a RGB ITU-R Recommendation BT.2020 color gamut for UHDTV. An older standard, ITU-R Recommendation BT.709, defines a smaller color gamut for HDTV. In SDR, the dynamic range is defined officially up to 100 nits (candela per square meter) for the color volume in which data are coded, although some display technologies may show brighter pixels.

High Dynamic Range pictures (HDR pictures) are color pictures whose luminance values are represented with a HDR dynamic that is higher than the dynamic of a SDR picture.

As explained extensively in “A Review of RGB Color Spaces” by Danny Pascale, a change of representation of a gamut, i.e. a transform that converts the three primaries and the white point from a linear color space to another, can be performed by using a 3×3 matrix in linear RGB color space. Also, a change of color space from XYZ to RGB is performed by a 3×3 matrix. As a consequence, whatever RGB or XYZ are the color spaces, a change of gamut can be performed by a 3×3 matrix. For example, a change of gamut representation from BT.2020 linear RGB to BT.709 XYZ can be performed by a 3×3 matrix.

The HDR dynamic is not yet defined by a standard but one may expect a dynamic range of up to a few thousand nits. For instance, a HDR color volume is defined by a RGB BT.2020 color space and the values represented in said RGB color space belong to a dynamic range from 0 to 4000 nits. Another example of HDR color volume is defined by a RGB BT.2020 color space and the values represented in said RGB color space belong to a dynamic range from 0 to 1000 nits.

Color-grading a picture (or a video) is a process of altering/enhancing the colors of the picture (or the video). Usually, color-grading a picture involves a change of the color volume (color space and/or dynamic range) or a change of the color gamut relative to this picture. Thus, two different color-graded versions of a same picture are versions of this picture whose values are represented in different color volumes (or color gamuts) or versions of the picture whose at least one of their colors has been altered/enhanced according to different color grades. This may involve user interactions.

For example, in cinematographic production, a picture and a video are captured using tri-chromatic cameras into RGB color values composed of 3 components (Red, Green and Blue). The RGB color values depend on the tri-chromatic characteristics (color primaries) of the sensor. A first color-graded version of the captured picture is then obtained in order to get theatrical renders (using a specific theatrical grade). Typically, the values of the first color-graded version of the captured picture are represented according to a standardized YUV format such as BT.2020 which defines parameter values for UHDTV.

The YUV format is typically performed by applying a non-linear function, so called Optical Electronic Transfer Function (OETF) on the linear RGB components to obtain non-linear components R′G′B′, and then applying a color transform (usually a 3×3 matrix) on the obtained non-linear R′G′B′ components to obtain the three components YUV. The first component Y is a luminance component and the two components U,V are chrominance components.

Then, a Colorist, usually in conjunction with a Director of Photography, performs a control on the color values of the first color-graded version of the captured picture by fine-tuning/tweaking some color values in order to instill an artistic intent.

The known MPEG video coders, such as HEVC standard for example, are not compatible with HDR (High Dynamic Range) video. Furthermore, a lot of displays/terminals are not compatible with the HDR video.

In order to distribute compressed HDR video to a wide variety of displays/terminals and to make it possible to use known video coding tools, such MPEG video coding standards, an HDR video is distributed as an SDR video representative of the HDR with a more limited dynamic range and a set of parameters allowing reconstruct an HDR video from the SDR video. In such a system, the SDR video is compressed using known tools, such as the standard HEVC Main 10 profile.

On the encoding side, the HDR video is first decomposed into an SDR video, such a decomposition delivering a set of parameters suitable to reconstruct at the decoder or at display level an HDR video from the decoded SDR video. Such a set of parameters may be coded with the compressed SDR video, typically in optional syntax messages, such as SEI (Supplemental Enhancement Information) messages for the HEVC standard.

FIG. 3 depicts the HDR to SDR decomposition of an HDR picture. The HDR-to-SDR decomposition process aims at converting an input linear-light 4:4:4 HDR picture, to an SDR compatible version (also in 4:4:4 format). Such a process uses side information such as the mastering display peak luminance, colour primaries, and the colour gamut of the container of the HDR and SDR pictures. Such side information is determined from the characteristics of the picture or of the video. The HDR-to-SDR decomposition process generates an SDR backward compatible version from the input HDR signal, using an invertible process that guarantees a high quality reconstructed HDR signal.

In a step E30, from the input HDR picture and its characteristics (side information), mapping variables are derived. Such a step of mapping parameters derivation delivers a luminance mapping function LUT_{TM}, which allows to map a linear-light luminance value of the HDR picture into an SDR-like luma value.

In a step E31, the luminance signal is then mapped to an SDR luma signal using the luminance mapping variables. That is for each pixel of the input HDR picture, the luminance L is derived from the HDR linear light R, G, B values of the pixel and from the luminance mapping function as:

$$L = {A}_{1} [ \begin{matrix}R \\ G \\ B\end{matrix} ] ,$$

with A=[A₁ A₂ A₃]^{T} being the conventional 3×3 R′G′B′-to-Y′CbCr conversion matrix (e.g. BT.2020 or BT.709 depending on the colour space), A₁, A₂, A₃ being 1×3 matrices.

The linear-light luminance L is mapped to an SDR-like luma Yₚᵣₑ₀, using the luminance mapping function: Yₚᵣₑ₀=LUT_{TM}(L).

In a step E32, a conversion of the R, G, B colour to derive the chroma components of the SDR signal is applied. The chroma components Uₚᵣₑ₀, Vₚᵣₑ₀ are built as follows:

A pseudo-gammatization using square-root (close to BT.709 OETF) is applied to the RGB values of the pixel

$$[ \begin{matrix}{R}_{S} \\ {G}_{S} \\ {B}_{S}\end{matrix} ] = [ \begin{matrix}\sqrt{R} \\ \sqrt{G} \\ \sqrt{B}\end{matrix} ]$$

Then the Uₚᵣₑ₀ and Vₚᵣₑ₀ values are derived as follows

$$[ \begin{matrix}{U}_{pre 0} \\ {V}_{pre 0}\end{matrix} ] = [ \begin{matrix}{A}_{2} \\ {A}_{3}\end{matrix} ] [ \begin{matrix}{R}_{S} \\ {G}_{S} \\ {B}_{S}\end{matrix} ] \times 1024$$

This step results in a gamut shifting, that is changes in colour hue and saturation compared to the input HDR signal. Such gamut shifting is corrected by a step E34 of colour gamut correction.

In step E34, the chroma component values are corrected as follows:

$$[ \begin{matrix}{U}_{pre 1} \\ {V}_{pre 1}\end{matrix} ] = \frac{1}{{b}_{0} ( {Y}_{pre 0} )} \times [ \begin{matrix}{U}_{pre 0} \\ {V}_{pre 0}\end{matrix} ] = \frac{1024}{{b}_{0} ( {Y}_{pre 0} )} \times [ \begin{matrix}{A}_{2} \\ {A}_{3}\end{matrix} ] [ \begin{matrix}\sqrt{R} \\ \sqrt{G} \\ \sqrt{B}\end{matrix} ] ,$$

where A₂, A₃ are made of the second and third lines of coefficients of the conversion matrix from R′G′B′-to-Y′CbCr, and b₀ is a pre-processing colour correction LUT (for Look Up Table).
Then, the mapped luma component is corrected as follows:

Yₚᵣₑ₁=Yₚᵣₑ₀−ν×max(0, a×Uₚᵣₑ₁+b×Vₚᵣₑ₁), where a and b are pre-defined parameters and v is a control parameter enabling to control the saturation. The higher the value Y is, the more the picture is saturated.

The HDR picture to SDR picture decomposition results in an output SDR picture with pixels arrays Yₚᵣₑ₁Uₚᵣₑ₁Vₚᵣₑ₁.

The HDR reconstruction process is the inverse of the HDR-to-SDR decomposition process. FIG. 4 illustrates such an HDR reconstruction process. A decoded SDR picture comprises 3 arrays of pixels SDR_{y}, SDR_{cb}, SDR_{cr} corresponding respectively to the luma and chroma components of the picture. The HDR reconstruction process the following steps for each pixel of the SDR picture.

In a step E40, the values Uₚₒₛₜ₁ and Vₚₒₛₜ₁ are derived as follows for each pixel (x,y) of the SDR picture:

$$\{ \begin{matrix}{U}_{post 1} = {SDR}_{cb} [ x ] [ y ] - midSampleVal \\ {V}_{post 1} = {SDR}_{cr} [ x ] [ y ] - midSampleVal\end{matrix}$$

where midSampleVal is a predefined shifting constant.

In a step E41, the value Yₚₒₛₜ₁ for the pixel (x,y) of the SDR picture is derived as follows:

Yₚₒₛₜ₁=SDR_{y}[x][y]+ν×max(0,a×Uₚₒₛₜ₁+b×Vₚₒₛₜ₁),

where a and b are the same pre-defined parameters and v is a control parameter enabling to control the saturation, as in the decomposition process. Therefore, such parameters should be known to the reconstruction module. They may be part of HDR parameters coded with the compressed SDR picture are predefined at the decoder.

Such a step may possibly be followed by a clipping to avoid being out of the legacy signal range.

In a step E42, colour correction is performed. In step E42, Uₚₒₛₜ₁ and Vₚₒₛₜ₁ are modified as follows:

$$\{ \begin{matrix}{U}_{post 1} = {b}_{p} [ {Y}_{post 1} ] \times {U}_{post 1} \\ {V}_{post 1} = {b}_{p} [ {Y}_{post 1} ] \times {V}_{post 1}\end{matrix}$$

where bₚ is a post-processing colour correction LUT, that depends directly on the pre-processing colour correction LUTb₀.

The post-processing colour correction LUT bₚ can be determined by:

$${b}_{P} ( Y ) = \frac{{b}_{O} ( Y )}{K \times \sqrt{L ( Y )}} \qquad ( eq . 1 )$$

where K is a constant value, L is the linear-light luminance derived from L=invLUT_{TM}[Y], with invLUT_{TM} being the inverse function of the LUT_{TM}, and Y the luma value of the SDR signal.
   In step E43, RGB (HDR_{R}, HDR_{G}, HDR_{B}) values of pixels are reconstructed. In step E43, a value T is derived as:

T=k0×Uₚₒₛₜ₁×Vₚₒₛₜ₁+k1×Uₚₒₛₜ₁×Uₚₒₛₜ₁+k2×Vₚₒₛₜ₁×Vₚₒₛₜ₁

where k0, k1, k2 are predefined values depending on the SDR colour gamut. The value S0 is then initialized to 0, and the following applies:
If (T≦1), S0 is set to Sqrt(1−T)
Else, Uₚₒₛₜ₁ and Vₚₒₛₜ₁ are modified as follows:

$$\{ \begin{matrix}{U}_{post 1} = \frac{{U}_{post 1}}{\sqrt{T}} \\ {V}_{post 1} = \frac{{V}_{post 1}}{\sqrt{T}}\end{matrix}$$

The values R1, G1, B1 are derived as follows.

$$[ \begin{matrix}R 1 \\ G 1 \\ B 1\end{matrix} ] = {M}_{{Y}^{′} CbCr \text{-} to \text{-} {R}^{′} {G}^{′} {B}^{′}} \times [ \begin{matrix}S 0 \\ {U}_{post 1} \\ {V}_{post 1}\end{matrix} ]$$

where M_{Y′CbCr-to-R′G′B′} is the conventional conversion matrix from Y′CbCr to R′G′B′.

In a step E44, the RGB values from the HDR picture are then reconstructed from the SDR RGB values. In step E44, the values R2, G2, B2 are derived from R1, G1, B1 as follows:

$$\{ \begin{matrix}R 2 = invLUT [ {Y}_{post 1} ] \times R 1 \\ G 2 = invLUT [ {Y}_{post 1} ] \times G 1 \\ B 2 = invLUT [ {Y}_{post 1} ] \times B 1\end{matrix}$$

where invLUT corresponds to the square-root of the inverse look-up-table LUT_{TM} derived from the luma mapping parameters transmitted to the reconstruction module.

And the output samples HDR_{R}, HDR_{G}, HDR_{B} are derived from R2, G2, B2 as follows:

$$\{ \begin{matrix}{HDR}_{R} = R {2}^{2} \\ {HDR}_{G} = G {2}^{2} \\ {HDR}_{B} = B {2}^{2}\end{matrix}$$

A clipping may be applied to limit the range of the output HDR signal.

The process for deriving the LUT b₀ is independent from the content. It applies in the container colour gamut and takes into account the content colour gamut. In order to better control the HDR to SDR decomposition and thus the quality of the resulting SDR picture, the computation of the LUT b₀ is performed so as to control the color saturation of the derived SDR signal.

For computing the LUT b₀, for each luma value Y, the following steps are applied. The luminance L is generated using the inverse function of LUT_{TM}: L=invLUT[Y]. Then the best b₀[Y] for luminance L (and therefore for luma Y) is identified as follows. Values bₜₑₛₜ in a given pre-defined range are evaluated. For this, a cumulative error err associated to bₜₑₛₜ is computed as follows:
err is initialized to 0.
the RGB cube is scanned, and each RGB sample is modified to reach a luminance of 1 cd/m². Then, the modified RGB samples RGB_{SDR} are scaled by the luminance L as follows, for deriving HDR-like RGB samples RGB_{HDR}:

$$\{ \begin{matrix}{R}_{HDR} = L \times {R}_{SDR} \\ {G}_{HDR} = L \times {G}_{SDR} \\ {B}_{HDR} = L \times {B}_{SDR}\end{matrix}$$

The output sample YUV_{SDR} as described in the HDR-to-SDR decomposition process is built, with b₀=bₜₑₛₜ from the scaled RGB_{HDR} samples. Then, an error in the Lab color space, error_{ab}, between RGB′_{sdr} samples values reconstructed from the output sample YUV_{SDR} and RGB_{HDR} is computed. And err is updated as follows:

err=err+error_{ab}

The final value b₀[Y] corresponds to bₜₑₛₜ giving the lowest cumulated err value among all the tested bₜₑₛₜ values.

It can be seen that such a computation of the pre-processing colour correction b₀, and thus the post-processing colour correction bₚ, is complex and is time and resource consuming.

There is thus a need for a new method and apparatus for encoding at least one high dynamic range picture into a coded bitstream with lower complexity, and for a correspondingly decoding method and apparatus.

### 4. SUMMARY

According to an aspect of the present principle, a method for coding at least one high dynamic range picture into a coded bitstream is disclosed. Such a method comprises:
a step of selecting a predetermined post-processing colour correction function bₚ_{_}_{det} among a set of predetermined post-processing colour correction functions bₚ^{set}, according to at least one parameter computed from at least said high dynamic range picture,
a step of determining a pre-processing colour correction function b₀ from said selected predetermined post-processing colour correction function bₚ_{_}_{det},
a step of decomposing said high dynamic range picture, into a standard dynamic range picture, using said pre-processing colour correction function b₀,
a step of coding said standard dynamic range picture into said coded bitstream,
a step of coding at least one parameter for reconstructing said high dynamic range picture from said standard dynamic range picture decoded from said coded bitstream and a post-processing colour correction function bₚ_{_}_{dec}.

Preferably, said at least one parameter computed from said at least one high dynamic range picture is a saturation skew parameter.

According to this principle, the computation of the pre-processing colour correction function b₀ is simplified. On the encoder side, a set of pre-computed post-processing colour correction function is defined according for example to different characteristics of the HDR content. Then, a specific post-processing colour correction function is selected from this set for each HDR picture of the video according to a predetemined criterion. Then, the pre-processing colour correction function b₀ is further computed from the post-processing colour correction function. Complexity is thus reduced on the encoder side.

According to another embodiment, said encoding method further comprises:
a step of selecting a predetermined post-processing colour correction function bₚ_{_}_{default} known to a decoder,
a step of determining an adjustment function f_{adj} used to adjust said predetermined colour correction function bₚ_{_}_{default}, delivering an adjusted colour correction function b_{adj}, said adjustment function F being determined by taking into account said selected predetermined post-processing colour correction function bₚ_{_}_{default} and said predetermined post-processing colour correction function bₚ_{_}_{det},
said parameter for reconstructing said high dynamic range picture from said standard dynamic range picture being a set of pivot points representative of said adjustment function f_{adj}, and said post-processing colour correction function bₚ_{_}_{dec} being said adjusted post-processing colour correction function b_{adj}.

According to this embodiment, it is not needed at the decoder to know the predetermined post-processing colour correction function bₚ_{_}_{det}. A set of pivot points representative of an adjustment function f_{adj} is coded into the coded bitstream. Such pivot points make it possible to reconstruct at the decoder a high dynamic range picture from the coded standard dynamic range picture and predefined post-processing colour correction function bₚ_{_}_{default} which are known to the decoder. As an example, such predefined post-processing colour correction function bₚ_{_}_{default} could be post-processing colour correction function that are sent to the decoder for the whole sequence or that are already defined in a compression standard.

According to another embodiment, said parameter for reconstructing said high dynamic range picture from said standard dynamic range picture is an index representative of the selected predetermined post-processing colour correction function bₚ_{_}_{det}, and said post-processing colour correction function bₚ corresponds to said selected predetermined post-processing colour correction function bₚ_{_}_{det}.

According to this embodiment, the set of predetermined post-processing colour correction functions bₚ^{set} from which bₚ_{_}_{det} has been selected is known to the decoder. As an example, such a set may be predefined at the decoder. Such an embodiment makes it possible to reduce the decoder complexity since it is not necessary to adjust a predetermined post-processing colour correction function bₚ_{_}_{default}. Furthermore, the encoder complexity is further reduced since the adjustment function do not need to be computed at encoder side.

According to a variant, said method further comprises a step of coding into said coded bitstream a set of parameters representative of said set of predetermined post-processing colour correction functions bₚ^{set}.

According to this embodiment, the set of post-processing colour correction function bₚ^{set}, is coded into the coded bitstream at a sequence level or a group of pictures level for example. For example, such a set of post-processing colour function may be transmitted to the decoder after a cut detection or at Random Access point. This embodiment allows to adapt the set of post-processing colour correction function bₚ^{set} according to the characteristics of the video sequence.

A method for decoding at least one high dynamic range picture from a coded bitstream is also disclosed. Said decoding method comprises:
a step of decoding a standard dynamic range picture from said coded bitstream,
a step of decoding an index representative of a predetermined post-processing colour correction function bₚ_{_}_{det} among a set of predetermined post-processing colour correction functions bₚ^{set},
a step of reconstructing said high dynamic range picture from said decoded standard dynamic range picture and said predetermined post-processing colour correction function bₚ_{_}_{det}.

According to one embodiment, said decoding method further comprises a step of decoding from said coded bitstream a set of parameters representative of said set of predetermined post-processing colour correction functions bₚ^{set}.

Another aspect of the disclosure is an apparatus for coding at least one high dynamic range picture into a coded bitstream. Such a coding apparatus comprises:
means for selecting a predetermined post-processing colour correction function bₚ_{_}_{det} among a set of predetermined post-processing colour correction functions bₚ^{set}, according to at least one parameter computed from at least said high dynamic range picture,
means for determining a pre-processing colour correction function b₀ from said selected predetermined post-processing colour correction function bₚ_{_}_{det},
means for decomposing said high dynamic range picture, into a standard dynamic range picture, using said pre-processing colour correction function b₀,
means for coding said standard dynamic range picture into said coded bitstream,
means for coding at least one parameter for reconstructing said high dynamic range picture from said standard dynamic range picture decoded from said coded bitstream and a post-processing colour correction function bₚ_{_}_{dec}.

Preferably, said at least one parameter computed from said at least one high dynamic range picture is a saturation skew parameter.

Another aspect of the disclosure is an apparatus for decoding at least one high dynamic range picture from a coded bitstream.

According to one embodiment, such a decoding apparatus comprises:
means for decoding a standard dynamic range picture from said coded bitstream,
means for decoding an index representative of a predetermined post-processing colour correction function bₚ_{_}_{det} among a set of predetermined post-processing colour correction functions bₚ^{set},
means for reconstructing said high dynamic range picture from said decoded standard dynamic range picture and said predetermined post-processing colour correction function bₚ_{_}_{det}.

According to another embodiment, such a decoding apparatus further comprises means for decoding from said coded bitstream a set of parameters representative of said set of predetermined post-processing colour correction functions bₚ^{set}.

Another aspect of the disclosure is a computer program comprising software code instructions for performing any one of the embodiments described in the present disclosure, when the computer program is executed by a processor.

Another aspect of the disclosure is a bitstream representative of at least one coded high dynamic range picture comprising:
coded data representative of at least one standard dynamic range picture obtained from said high dynamic range picture,
coded data representative of an index representative of a predetermined post-processing colour correction function bₚ_{_}_{det} among a set of predetermined post-processing colour correction functions bₚ^{set}, said predetermined post-processing colour correction function bₚ_{_}_{det} being used for reconstructing said high dynamic range picture from said standard dynamic range picture decoded from said bitstream.

According to one embodiment, such a bitstream further comprises coded data representative of said set of parameters representative of said set of predetermined post-processing colour correction functions bₚ^{set}.

A non-transitory processor readable medium having stored thereon a bitstream is disclosed wherein the bitstream comprises:
coded data representative of at least one standard dynamic range picture obtained from said high dynamic range picture,
coded data representative of an index representative of a predetermined post-processing colour correction function bₚ_{_}_{det} among a set of predetermined post-processing colour correction functions bₚ^{set}, said predetermined post-processing colour correction function bₚ_{_}_{det} being used for reconstructing said high dynamic range picture from said standard dynamic range picture decoded from said bitstream.

### 5. BRIEF DESCRIPTION OF THE DRAWINGS

FIG. 1 illustrates an exemplary system for encoding an HDR picture into a coded bitstream according to an embodiment of the present principle.

FIG. 2 illustrates an exemplary system for decoding an HDR picture into a coded bitstream according to an embodiment of the present principle.

FIG. 3 illustrates a block diagram of an exemplary method for decomposing an HDR picture into an SDR picture.

FIG. 4 illustrates a block diagram of an exemplary method for reconstructing an HDR picture from an SDR picture decoded from a coded bitstream.

FIG. 5 illustrates a block diagram of an exemplary method for coding an HDR picture into a coded bitstream according to an embodiment of the present principle.

FIG. 6 illustrates a block diagram of an exemplary method for computing a set of post-processing colour function, according to an embodiment of the present principle.

FIG. 7 illustrates a block diagram of an exemplary method for coding an HDR picture into a coded bitstream according to another embodiment of the present principle.

FIG. 8 illustrates a block diagram of an exemplary method for decoding an HDR picture from a coded bitstream according to an embodiment of the present principle.

FIG. 9 illustrates a block diagram of an exemplary method for decoding an HDR picture from a coded bitstream according to another embodiment of the present principle.

FIG. 10 shows examples of chromaticity diagrams.

FIG. 11 illustrates an exemplary apparatus for implementing one of the methods disclosed herein according to an embodiment of the present principle.

FIG. 12 illustrates an embodiment of a method for computing the pre-processing colour correction function b0[k] are obtained from at least one saturation skew parameter satskew computed from at least one high dynamic range picture.

FIG. 13 illustrates an embodiment of the method for computing a satskew value for a HDR picture.

### 6. DESCRIPTION OF EMBODIMENTS

FIG. 1 illustrates an exemplary system for encoding an HDR picture into a coded bitstream according to an embodiment of the present principle. Such an encoding system may be used for distributing a compressed HDR video while at the same time distributing an associated SDR video representative of the HDR video with a more limited dynamic range. Such an encoding system provides a solution for SDR backward compatible HDR distribution.

The disclosure is described for encoding/decoding a color HDR picture but extends to the encoding/decoding of a sequence of pictures (video) because each color picture of the sequence is sequentially encoded/decoded as described below.

An HDR picture is first input to a module of HDR to SDR decomposition. Such a module performs HDR to SDR decomposition and outputs an SDR picture which is a dynamic reduced version of the input HDR picture.

The output SDR picture is a reshaped version of the input HDR picture such that the hue and perceived saturation are preserved and the visual quality of the SDR picture relative to the HDR picture is increased. The HDR to SDR decomposition module also outputs a set of HDR parameters which are further used for HDR picture reconstruction.

Such a set of HDR parameters comprises at least luma mapping parameters allowing to derive an inverse luma mapping table for converting SDR luma to HDR luminance.

The SDR picture is then input to an encoding module performing picture encoding. Such an encoding module may be for example an HEVC Main 10 coder suitable for encoding video and picture represented on a 10 bit-depth. The encoding module outputs a coded bitstream representative of a compressed version of SDR picture. The HDR parameters are also encoded by the encoding module as part of the coded bitstream. As an example, such HDR parameters may be coded in SEI message (Supplemental Enhancement Information message) of an HEVC Main 10 bitstream.

Such a coded bitstream may then be stored or transmitted over a transmission medium.

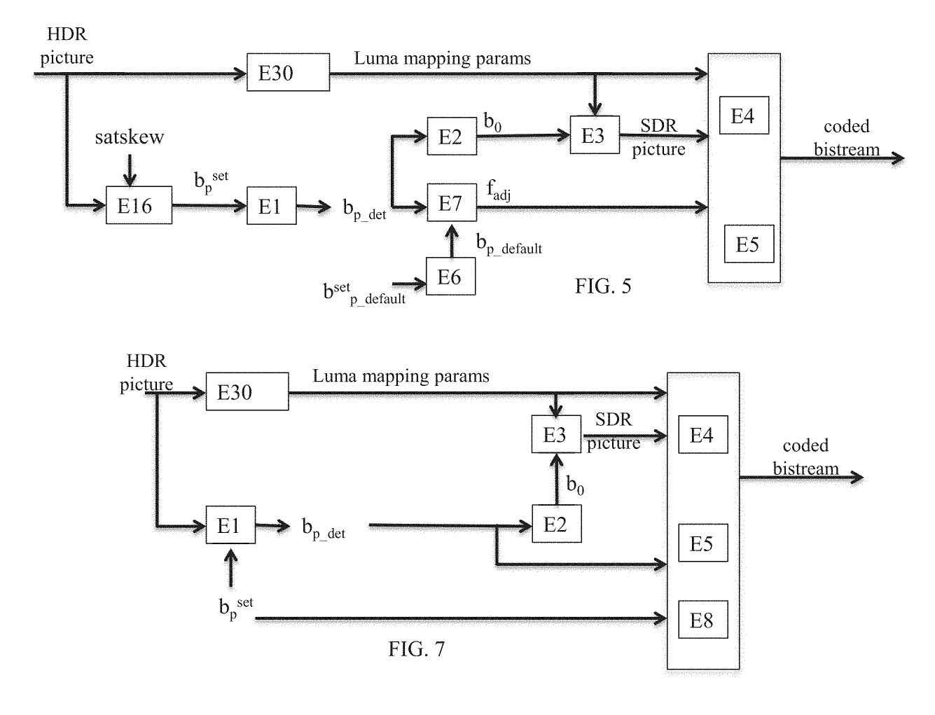

The method steps of the encoding system presented here are further describes according to various embodiments disclosed herein with FIGS. 5 and 7.

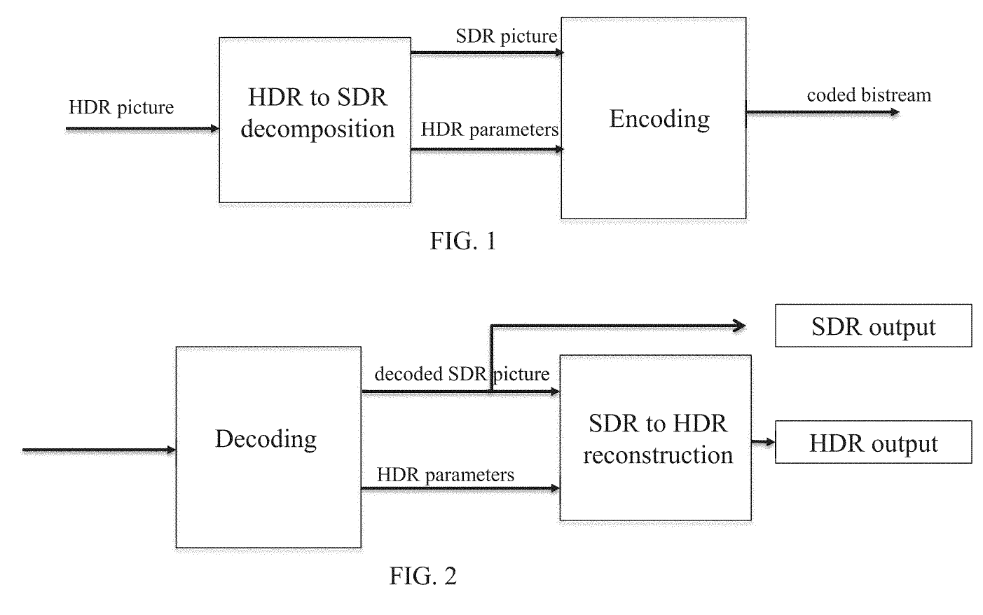

FIG. 2 illustrates an exemplary system for decoding an HDR picture from a coded bitstream according to an embodiment of the present principle. As an example, the coded bitstream is conformed to the HEVC Main 10 profile.

Such a coded bitstream comprises coded data representative of an SDR picture and coded data representative of HDR parameters suitable for reconstructing an HDR picture from a decoded version of the SDR picture compressed in the coded bitstream.

Such a coded bitstream may be stored in a memory or received from a transmission medium.

The coded bitstream is first input to a decoding module performing picture decoding and HDR parameters decoding. The decoding module may be for example a decoder conformed to an HEVC Main 10 profile decoder.

The decoding module outputs a decoded SDR picture and a set of HDR parameters. The decoded SDR picture may be displayed by a legacy SDR display (SDR output). Such an SDR picture may be viewable by an end-user from his legacy SDR display. Thus, the disclosed system is backward compatible with any SDR legacy display.

The decoded SDR picture and HDR parameters are then input to a module for SDR to HDR reconstruction. Such a module reconstructs the HDR picture from the decoded SDR picture using the given HDR parameters. Then, a decoded HDR picture is output and can be displayed by an HDR compatible display (HDR output).

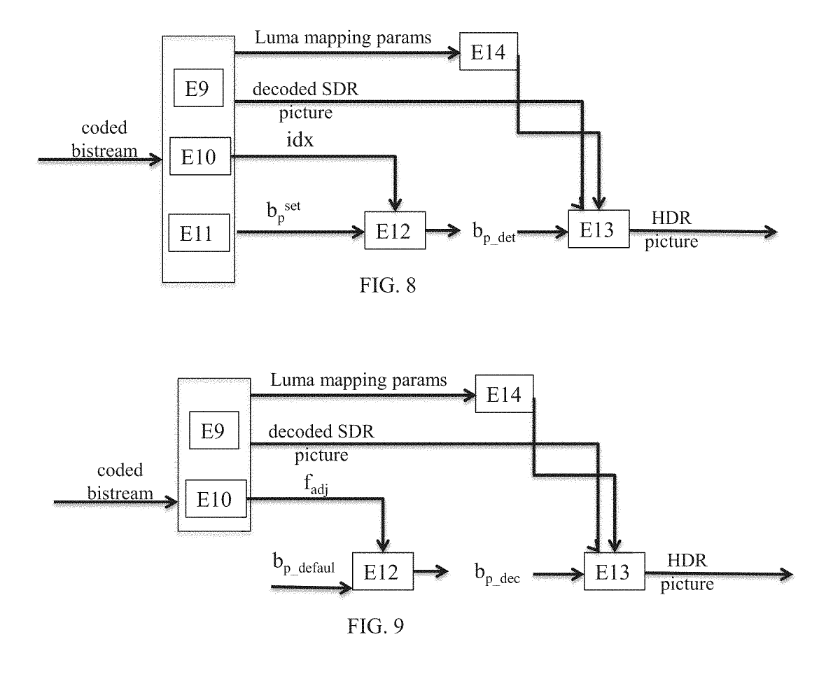

The method steps of the decoding system presented here are further describes according to various embodiments disclosed herein with FIGS. 8 and 9.

1—Coding an HDR Picture into a Coded Bitstream:

FIG. 5 illustrates a block diagram of an exemplary method for coding an HDR picture into a coded bitstream according to an embodiment of the present principle.

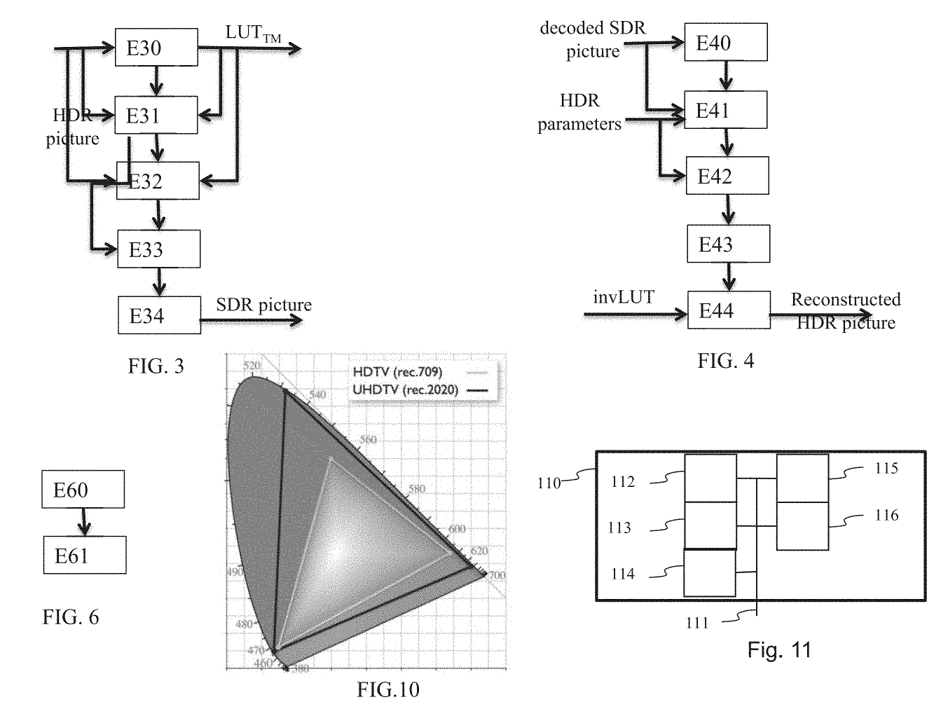

In step E30, luma mapping parameters are first computed according to step E30 already described with FIG. 3. Luma mapping parameters allows to derive the LUT for converting linear light luminance of the HDR picture into luma samples of the SDR picture and to derive an inverse LUT for converting the luma samples of a decoded SDR picture into luminance of a reconstructed HDR picture.

In an optional step E16, a set of predetermined post-processing colour correction functions bₚ^{set} is obtained from at least one saturation skew parameter computed from at least said high dynamic range picture.

According to an embodiment of the step E16, the set of predetermined post-processing colour correction functions bₚ^{set} is obtained from a saturation skew parameter called satskew computed from a high dynamic range picture according to, for example, the method described in relation with FIG. 6.

If one satskew value is associated to each predetermined post-processing colour correction functions bₚ^{set}, the derivation of the satskew value from the high dynamic range picture to identify the post-processing colour correction function can be replaced by the direct identification of an index i which identifies the corresponding ith post-processing colour correction function. According to an embodiment of the step E16, the set of predetermined post-processing colour correction functions bₚ^{set} is obtained from an index.

In a step E1, a first predetermined post-processing colour correction function bₚ_{_}_{det} is selected among a first set of predetermined post-processing colour correction functions bₚ^{set}, according to at least one parameter p_{HDR} computed from at least said high dynamic range picture, for instance the saturation skew parameter used in step E16.

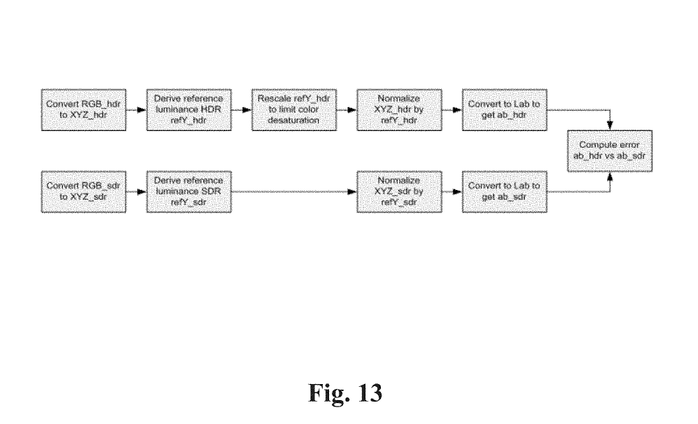

More generally, the set of predetermined post-processing colour correction functions bₚ^{set} comprises pre-computed post-processing correction function bₚ(k), with k=0 to Nk, where Nk is the number of post-processing colour correction functions of the first set bₚ^{set}. Each pre-computed post-processing correction function bₚ(k) corresponds to given characteristics of HDR content, such as color saturation or hue for example, or corresponds to a value of the parameter satskew. Equivalently, an index, actually related to the satskew value, can be derived to identify the predetermined post-processing colour correction function bₚ_{_}_{det}. According to an embodiment, the satskew parameter is computed for at least the HDR picture according to the method described in relation with FIG. 13.

Each post-processing colour correction function bₚ(k) of the set bₚ^{set} is thus associated with a parameter p(k) representative of a color rendering of an SDR picture obtained using the post-processing colour correction function bₚ(k). Such a representative parameter p(k) could be representative of the hue or saturation level of the picture as an example.

According to an embodiment of the present principle, at least one parameter p_{HDR} is extracted from the HDR picture to code, such as the hue or color saturation level. Such parameters are obtained from an analysis of the HDR picture and are used to select a post-processing colour correction function bₚ_{_}_{det} among the first post-processing colour correction function set bₚ^{set} using the corresponding representative parameter p(k) which has been associated with the post-processing colour correction functions bₚ(k) of the set bₚ^{set}.

In a step E2, a pre-processing colour correction function b₀ is determined in a manner known per se (see step E42 above) from the selected post-processing colour correction function bₚ_{_}_{det} such that, when applied to the luminance component of the HDR picture, luminance of a SDR picture is obtained. The pre-processing colour correction and post-processing colour correction function are for instance directly linked by equation eq.1 discussed above. The pre-processing colour correction function b₀ is thus determined as follows for each Y values:

b₀(Y)=bₚ_{_}_{det}(Y)×K×\sqrt{L(Y)},
where K is a constant value, L is the linear-light luminance derived from L=invLUT[Y], with invLUT being the inverse function of the LUT_{TM}.

In a step E3, the HDR picture is decomposed into an SDR picture, using the pre-processing colour correction function b₀ determined as in step E2 and the luma mapping parameters obtained in step E30. Such a decomposition process is performed in a similar manner as described in relation with FIG. 3.

In a step E4, the SDR picture is then coded into a coded bitstream. Any picture or video coding method may be used. For example, an HEVC Main 10 profile encoder may be used.

The luma mapping params are also coded into the coded bitstream so as to make it possible to derive the inverse LUT mapping luminance.

In a step E5, at least one parameter for reconstructing said HDR picture from a decoded version of said SDR picture and from a post-processing colour correction function bₚ_{_}_{dec} is coded into said coded bitstream.

According to an embodiment, such at least one parameter corresponds to a set of pivot points representative of a piecewise linear adjustment function f_{adj} used on the decoding side, to adjust as described below a default post-processing colour correction function bₚ_{_}_{default} to the post-processing colour correction function bₚ_{_}_{det} determined at step E1. As this function is piecewise linear, each linear segment between any two neighbored pivot points can be determined such as to define this adjustment function.

In a step E6, a second predetermined post-processing colour correction function bₚ_{_}_{default} is selected among a second set of predetermined post-processing colour correction function b^{set}ₚ_{_}_{default}. The second set b^{set}ₚ_{_}_{default} comprises pre-defined default LUTs bₚ_{_}_{default}[k], k=1 to N, which are predefined on the decoder side. For instance, one LUT is defined for each triple (container colour gamut, content colour gamut, peak luminance). In step E6, bₚ_{_}_{default} is selected from this second set according to the HDR picture characteristics (container colour gamut, content colour gamut, peak luminance). Such characteristics are part of the picture parameters and are sent to the decoder into the coded bitstream. On the decoder side, it is thus possible to select the corresponding post-processing colour correction function bₚ_{_}_{default}.

At a step E7, an adjustment function f_{adj} is determined. Said adjustment function f_{adj} is determined by taking into account said selected predetermined post-processing colour correction function bₚ_{_}_{default} and said predetermined post-processing colour correction function bₚ_{_}_{det} selected at step E1. The adjustment function f_{adj} is built to map as much as possible the function b_{P}_{_}_{default} to the selected function bₚ_{_}_{det} by minimizing the difference between bₚ_{_}_{det} and bₚ_{_}_{dec} where bₚ_{_}_{dec} is set as:

bₚ_{_}_{dec}[Y]=f_{adj}[Y]×bₚ_{_}_{default}[Y] (eq.2)

The adjustment function f_{adj} is built so that bₚ_{_}_{dec} is as close as possible to bₚ_{_}_{det} for all Y values. In the present embodiment, f_{adj} is by minimization of an error based on equation eq.2, however any types of relationship may be used.

Then, the f_{adj} function is coded in step E5 and transmitted to the decoder side. The function f_{adj} is modeled using pivot points of a piece-wise linear model. In step E5, only the set of pivot points representative of the f_{adj} function are coded. Each x and y components of such pivot points are coded into the coded bitstream, for example as part of the HDR parameters as described in FIG. 1.

According to a variant, the set of predetermined post-processing colour correction functions bₚ^{set} comprises a single pre-computed post-processing correction function bₚ.

According to a variant, the set of predetermined post-processing colour correction functions bₚ^{set} is obtained for each high dynamic range picture of a video sequence.

FIG. 7 illustrates a block diagram of another exemplary method for coding an HDR picture into a coded bitstream according to another embodiment of the present principle.

In this embodiment, steps E30, E1, E2, E3 and E4 are performed similarly as in the embodiment described with FIG. 5.

According to the embodiment described with FIG. 7, the third post-processing colour correction function bₚ_{_}_{dec} used at the decoder to recontruct the HDR picture is obtained from the same first set of pre-computed post-processing colour correction function bₚ^{set}. Therefore, there is no need to compute an adjustment function as in the previous described embodiment.

According to the present embodiment, in step E5, an index idx is coded into the coded bitstream, for example using a fixed length code. Said index idx is representative of the first predetermined post-processing colour correction function bₚ_{_}_{det} selected from the first set bₚ^{set}.

In this embodiment, such a first set bₚ^{set} should be known at the decoder. For instance, the first set of post-processing colour correction functions is predefined at the decoder.

Alternatively, in a step E8, such a first set bₚ^{set} of post-processing colour correction functions is coded into the coded bitstream and transmitted to the decoder. For example, this first set bₚ^{set} is coded at a sequence level with the video sequence parameters and stored by the decoder during all the decoding process of the pictures of the video.

Each post-processing colour correction function bₚ(k) of the first set bₚ^{set} is coded as a one dimension array comprising a number of NbY elements, where NbY represents the number of luma values Y of the SDR picture.

According to a preferred variant of this embodiment, the corresponding representative parameter p(k) associated with a post-processing colour correction function bₚ(k) is also coded into the coded bitstream. According to this variant, the selected first post-processing colour correction bₚ_{_}_{det} could be determined at the decoder using a corresponding parameter p_{HDR} which could be sent to the decoder. As an example, such parameter p_{HDR} is coded into the coded bitstream with information at a picture parameter level.

Each function of the set bₚ^{set} is coded as a one dimension array comprising a number of N elements, where N represents the number of luma values Y of the SDR picture.

FIG. 6 illustrates a block diagram of an exemplary method for computing a set of post-processing colour function bₚ^{set}, according to an embodiment of the present principle.

According to a first variant, before encoding pictures of a video sequence, Nk post-processing colour correction LUT bₚ(k) are pre-computed. Each post-processing colour correction LUT bₚ(k) is associated with a parameter p(k) representative of a color rendering of an SDR picture (e.g hue or saturation level) derived using such post-processing colour correction LUT bₚ(k). These post-processing colour correction LUTs bₚ(k) are computed using a learning process from a large set of representative HDR pictures.

In a step E60, for each HDR picture of this set, a default post-processing colour correction bₚ^{def} LUT is used to generate a default SDR picture. The SDR picture is generated according to the decomposition process described according to FIG. 3, using a pre-processing colour correction function b₀^{def} computed from the default post-processing colour correction bₚ^{def} LUT. The pre-processing colour correction function b₀^{def} computed from the default post-processing colour correction bₚ^{def} LUT is obtained for each luma value Y, by:

b₀_{ₚ}^{def}(Y)bₚ^{def}(Y)×K×\sqrt{L(Y)},

where K is a constant value, L is the linear-light luminance derived from L=invLUT_{TM}[Y], with invLUT_{TM} being the square-root of the inverse function of the LUT_{TM}.

Starting from this default SDR picture, a colorist modifies this default post-processing colour correction LUT bₚ^{def} for optimizing the color rendering of the SDR picture (hue or/and saturation). The resulting post-processing colour correction LUT bₚ^{res} is associated with the HDR input picture.

In a step E61, a classification algorithm gathers the HDR pictures presenting common characteristics in a subset. For each subset of HDR pictures, an average of the LUTs bₚ^{res} associated with the HDR pictures of the subset is computed to obtain one representative post-processing colour correction LUT bₚ(k) per subset. The classification algorithm resulted in a number of Nk subsets, each subset k being associated with a representative post-processing colour correction LUT bₚ(k).

In a step E62, for each subset k, at least one parameter p(k) is extracted from the HDR pictures of the subset, such as saturation level or hue. Such an extracted parameter is representative of the subset. This parameter allows to distinguish the subsets.

In the coding method described according to one embodiment, in reference to FIG. 5 or 7, such a parameter p(k) enables to identify a correct post-processing colour correction LUT bₚ(k) to get the optimal color rendering for a target HDR picture. For instance, after a pre-analysis of hue and saturation histograms of a target HDR picture, a corresponding parameter p_{HDR} can be derived from an average of the HDR saturation of the HDR picture.

At the end of the post-processing colour correction LUT computation method described above, the set of post-processing colour function bₚ^{set} comprises the Nk post-processing colour correction function computed at step E61.

Then, the computed set of post-processing colour function bₚ^{set} and the corresponding representative parameter of each subset associated with a post-processing colour correction function bₚ(k) are input to step E1 for selecting a post-processing colour correction function bₚ_{_}_{det} as disclosed in FIG. 5 or 7.

According to a second variant, before encoding pictures of a video sequence, K post-processing colour correction LUT bₚ are pre-computed for the whole sequence. For example, K is equal to 3.

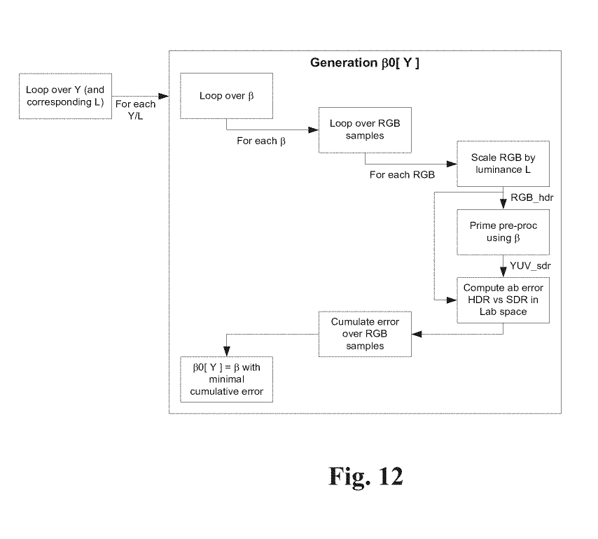

In a step E60, a pre-processing LUT b₀[k] (k going from 0 to K), are first computed according, for example, to the method described in relation with FIG. 12. These pre-processing LUT b₀[k], are computed using the error_{ab} minimization for one pre-processing colour correction function computed for a current picture. The pre-processing LUT b₀[k] may be computed for each picture or once for all the pictures of a video sequence. Therefore, it is not necessary to compute a pre-processing colour correction function for each picture of the sequence as in the prior art.

In the present embodiment, each pre-processing LUT b₀[k] is computed for different saturation skew values. For instance, in the case where K is equal to 3, the following saturation skew values are used:
b₀[0] is computed for a saturation skew equals to 5,
b₀[1] is computed for a saturation skew equals to 10,
b₀[2] is computed for a saturation skew equals to 15.

As these pre-processing LUT are computed for all the pictures of a video sequence, in the present embodiment, the minimization is done with a large number of Tone Mapping parameters. This allows to optimize the accuracy of the computed LUT compared to the minimization described above in which one Tone Mapping parameters (the one of the current picture) was used.

In a variant, the LUT may be computed off-line (no real-time limitation). Then the minimization can be done with full precision that alos optimizes the accuracy of the LUT.

In a step E61, for each k from 0 to K−1, the post-processing colour correction function bₚ[k] are derived from the pre-processing colour correction function b₀[k] computed at step E60, using equation (3) disclosed above:

$${b}_{p} [ k ] ( Y ) = \frac{{b}_{0} [ k ] ( Y )}{K \times \sqrt{L ( Y )}}$$

The set of post-processing colour function bₚ^{set} comprises the K post-processing colour correction function computed at step E61.

Then, the computed set of post-processing colour function bₚ^{set} is input to step E1 for selecting a post-processing colour correction function bₚ_{_}_{det} as described in relation with FIG. 5 or 7.

FIG. 12 illustrates an embodiment of a method for computing the pre-processing colour correction function b₀[k] is obtained from at least one saturation skew parameter satskew computed from a high dynamic range picture.

According to this embodiment, the pre-processing colour correction function b₀[k] are obtained from a minimization of an error value error_{ab} (expressed in Lab color space), between RGB_{sdr} and RGB_{hdr}.

The process is independent from the content. It applies in the container colour gamut and takes into account the content color gamut. In order to better control the HDR to SDR decomposition and thus the quality of the resulting SDR picture, the computation of a pre-processing colour correction function b₀[k] is controlled by a satskew parameter (saturation skew parameter). Thus, the color saturation of the derived SDR signal can be controlled.

For computing the pre-processing colour correction function b₀[k], for each luma value Y of a HDR picture, the following steps are applied:

In a step 130, the luminance L is generated using the inverse function of LUT_{TM}: L=invLUT[Y].

In step 140, the best β₀[Y] for luminance L (and therefore for luma Y) is identified as follows:

For each luma value Y,
1) For each potential value βₜₑₛₜ belonging a given pre-defined range,
   1.1) A cumulative error value errₜₑₛₜ=0;
   1.2) For each RGB sample:
      1.2.1) the RGB sample is modified, to reach a luminance of 1 cd/m², by:

$$\{ \begin{matrix}{R}_{HDR} = L \times {R}_{SDR} \\ {G}_{HDR} = L \times {G}_{SDR} \\ {B}_{HDR} = L \times {B}_{SDR}\end{matrix}$$

1.2.2) an output value YUV_{SDR} is computed from the HDR-to-SDR decomposition process with β₀=βₜₑₛₜ from the scaled RGB_{HDR} samples;
1.2.3) an error in the CIE Lab color space is calculated between YUV_{SDR} and RGB_{HDR} and this error is added to the cummlative error value errₜₑₛₜ;
2) The final value β₀[Y] corresponds to βₜₑₛₜ giving the lowest cumulated error value among all the cumulative error values.

According to an embodiment of the step 1.2.3, an error in the Lab is calculated between YUV_{SDR} and RGB_{HDR} as follows:

Convert RGB_hdr to XYZ_hdr (container gamut)

Generate reference Yref_hdr for HDR
Yref_hdr=Y_hdr
Yref_hdr is reduced to resaturate more the perceived color and avoid chroma overshooting—this is controled by an input parameter saturation_skew (typically set to around 5 nits)
   If Yref_hdr>saturation_skew

$$Yref\_hdr = Yref\_hdr \times {( \frac{Yref\_hdr}{saturation\_skew} )}^{ga} with$$

$$ga = \frac{log ( \frac{P}{100 * saturation\_skew} )}{log ( \frac{P}{saturation\_skew} )}$$

XYZ_hdr divided by Yref_hdr (normalization), then conversion to ab_hdr

a_hdr=500×(f(X_hdr)−f(Y_hdr))

b_hdr=200×(f(Y_hdr)−f(Z_hdr))
Convert RGB_sdr to XYZ_sdr (container gamut)
XYZ_sdr divided by Yref_sdr=Y_sdr (normalization), then conversion to ab_sdr

a_sdr=500×(f(X_sdr)−f(Y_sdr))

b_sdr=200×(f(Y_sdr)−f(Z_sdr))

error=(a_hdr−a_sdr)²+(b_hdr−b_sdr)²

FIG. 13 illustrates an embodiment of the method for computing a satskew value for a HDR picture.

The HDR picture is analyzed and hue and saturation histograms are computed for the HDR picture. Then a pre-analysis of such histograms is used to determine the satskew parameter as follows. The higher the saturation is, the more the satskew value will increase. The satskew parameter is then used to select a post-processing colour correction function bₚ_{_}_{det} among the post-processing colour correction function set bₚ^{set}.

The satskew parameter value is determined using histograms based on the HDR picture characteristics (saturation, hue, luma). The algorithm is summarized by the following:
Computation of the histogram saturation and mean luminance on the HDR picture (linear);
Computation, on the 5% most saturated pixels of the image, of the hue values;
Computation, on the 10% most saturated pixels of the image, of the hue values;
Computation, on the 20% most saturated pixels of the image, of the hue values; and
Determination of the satskew value using metrics.
   The saturation and hue are computed in the sRGB domain in order to make it easier to separate the different colors.

$$\{ \begin{matrix}{R}^{′} = sRGB ( R ) \\ {G}^{′} = sRGB ( G ) \\ {B}^{′} = sRGB ( B )\end{matrix}$$

Where the sRGB function is:

$$if ( v < 0.0031308 ) sRGB ( v ) = max ( 0 , v * 12.92 ) , \\ else sRGB ( v ) = 1.055 * {v}^{\frac{1}{2.4}} - 0.055$$

### Computation of the Saturation Histogram and Metrics

We define maxRGB as maxRGB=max[R′,B′,G′] and minRGB as minRGB=min [R′,B′,G′]
The saturation S is computed by:

$$\{ \begin{matrix}if ( max RGB > 0.01 ) S = \frac{max RGB - min RGB}{max RGB} \\ else max RGB = 0\end{matrix}$$

By definition, the saturation is included in [0; 1]. The histogram is computed on all the picture and consists in 101 bins of witdth 0.01 for example.
From the highest to the lowest saturations, we sum the histogram bin size until we get 5%, 10% and 20% of the image size. This allows us to define S_{5P}, S_{10P}, S_{20P} as the sets of pixels that are the 5%, 10% and 20% percent most saturated pixels of the image. These pixels can be characterized by saturation, hue and luminance metrics. The average saturation values S̅_̅{̅5̅P̅}̅, S̅_̅{̅1̅0̅P̅}̅, S̅_̅{̅2̅0̅P̅}̅ are computed on these three sets.

### Computation of the Luminance Metrics

The luminance is averaged on S̅_̅{̅5̅P̅}̅, S̅_̅{̅1̅0̅P̅}̅, S̅_̅{̅2̅0̅P̅}̅ to get the
meanL_{5P},meanL_{10P},meanL_{20P} metrics.
The luminance is computed by

L=M₁R+M₂G+M₃B

Where, in a 709 container:
M₁=0.2126
M₂=0.7152
M₃=0.0722
   And in a 2020 container:
M₁=0.2627
M₂=0.6780
M₃=0.0593
   The mean luminance is computed on the complete image.

### Computation of the Hue Histograms and Metrics

The algorithm needs to determine the main color of the most saturated pixels. Therefore, while computing the saturation histogram, hue histograms are also computed.
The hue values represent color through angles. The red colors are around 0°, the green colors are around 120° and the blue colors are around 240°.
The hue value is determination is the
following:

$$\{ \begin{matrix}if ( max RGB - min RGB < 0.001 ) , hue = undefined \\ if ( max RGB ) = {R}^{′} ) , {hue}_{R} = ( [ \frac{{G}^{′} - {B}^{′}}{max RGB - min RGB} ] * 60 ) \%360 \\ if ( max RGB ) = {G}^{′} ) , {hue}_{G} = ( [ \frac{{B}^{′} - {R}^{′}}{max RGB - min RGB} + 2 ] * 60 ) \%360 \\ if ( max RGB ) = {B}^{′} ) , {hue}_{B} = ( [ \frac{{R}^{′} - {G}^{′}}{max RGB - min RGB} + 4 ] * 60 ) \%360\end{matrix}$$

Hence three histograms are computed (hue_hist_R for the red colors which contains the hue_{R} values, hue_hist_G for the green colors which contains the hue_{G} values and hue_hist_B for the blue colors whiche contains the hue_{E} values). Only the defined hue values are considered in the rest of the algorithm.
The hue histograms are indexed by saturation values and consists also in 101 bins of width 0.01. From the S_{5P}, S_{10P}, S_{20P} are derived the sets:
H_{R}_{_{5P}}, H_{R}_{_{10P}}H_{R}_{_{20P}} from the hue_hist_R histogram
H_{G}_{_{5P}}, H_{G}_{_{10P}}H_{G}_{_{20P}} from the hue_hist_G histogram
H_{B}_{_{5P}}, H_{B}_{_{10P}}H_{B}_{_{20P}} from the hue_hist_B histogram
Mean hues values are computed on the previous nine sets. The mean hue value of hi,i_{=1:n} hue values is averaged by the following:

$$\overline{hue} = atan ( \frac{{\sum }_{i = 1}^{n} sin ( {h}_{i} )}{{\sum }_{i = 1}^{n} cos ( {h}_{i} )} )$$

The mean hue values are computed for the hue_hist_R, hue_hist_G, hue_hist_B histograms. Therefore we have 9 metrics:
   h̅u̅e̅_{R}_{_}_{S}_{_}_{5P}, h̅u̅e̅_{R}_{_}_{S}_{_}_{10P}, h̅u̅e̅_{R}_{_}_{S}_{_}_{20P}
   h̅u̅e̅_{B}_{_}_{S}_{_}_{5P}, h̅u̅e̅_{B}_{_}_{S}_{_}_{10P}, h̅u̅e̅_{B}_{_}_{S}_{_}_{20P}
   h̅u̅e̅_{G}_{_}_{S}_{_}_{5P}, h̅u̅e̅_{G}_{_}_{S}_{_}_{10P}, h̅u̅e̅_{G}_{_}_{S}_{_}_{20P}
      In addition, we also compute the color ratios:

$${ratio}_{R 5 P} = \frac{size ( {H}_{R 5 P} )}{size ( {H}_{R 5 P} ) + size ( {H}_{G 5 P} ) + size ( {H}_{B 5 P} )}$$

$${ratio}_{R 10 P} = \frac{size ( {H}_{R 10 P} )}{size ( {H}_{R 10 P} ) + size ( {H}_{G 10 P} ) + size ( {H}_{B 10 P} )}$$

$${ratio}_{R 20 P} = \frac{size ( {H}_{R 20 P} )}{size ( {H}_{R 20 P} ) + size ( {H}_{G 20 P} ) + size ( {H}_{B 20 P} )}$$

$${ratio}_{G 5 P} = \frac{size ( {H}_{G 5 P} )}{size ( {H}_{R 5 P} ) + size ( {H}_{G 5 P} ) + size ( {H}_{B 5 P} )}$$

$${ratio}_{G 10 P} = \frac{size ( {H}_{G 10 P} )}{size ( {H}_{R 10 P} ) + size ( {H}_{G 10 P} ) + size ( {H}_{B 10 P} )}$$

$${ratio}_{G 20 P} = \frac{size ( {H}_{G 20 P} )}{size ( {H}_{R 20 P} ) + size ( {H}_{G 20 P} ) + size ( {H}_{B 20 P} )}$$

$${ratio}_{B 5 P} = \frac{size ( {H}_{B 5 P} )}{size ( {H}_{R 5 P} ) + size ( {H}_{G 5 P} ) + size ( {H}_{B 5 P} )}$$

$${ratio}_{B 10 P} = \frac{size ( {H}_{B 10 P} )}{size ( {H}_{R 10 P} ) + size ( {H}_{G 10 P} ) + size ( {H}_{B 10 P} )}$$

$${ratio}_{B 20 P} = \frac{size ( {H}_{B 20 P} )}{size ( {H}_{R 20 P} ) + size ( {H}_{G 20 P} ) + size ( {H}_{B 20 P} )}$$

Determination of the Satskew Value from Metrics
The algorithm is based on the comparison of the previous metrics with some thresholds. An example for three satskew values (5, 10 and 15) is proposed.
We define the thresholds used for a ten satskew value by:
threshold_sat10_at_5p=0.95
threshold_sat10_at_10p=0.9
threshold_sat10_at_20p=0.8
The thresholds used for a fifteen satskew value by:
threshold_sat15_at_5p=0.99
threshold_sat15_at_10p=0.9
threshold_sat15_at_20p=0.9
The saturation loss is expressed by:
threshold_20p_10p=0.8
   In case of images where red represent a large part of saturated pixels, the thresholds are changed
   if (ratio_{R20P}>0.5) then
threshold_sat10_at_5p=0.95
threshold_sat10_at_10p=0.9
threshold_sat10_at_20p=0.8
threshold_sat15_at_5p=0.95
threshold_sat15_at_10p=0.9
threshold_sat15_at_20p=0.8
threshold_20 p_10p=0.8
   The satskew value, or equivalently, an index k, is the derived according to the following steps.

$$if ( ( {\overline{hue}}_{{R}_{{S}_{20 P}}} < 8 ) \&\& ( {\overline{hue}}_{{R}_{{S}_{20 P}}} > - 8 ) ) pure\_red \_color = true if ( ( \overline{{S}_{5 P}} > threshold\_sat15 \_at \_ 5 p ) \&\& ( \frac{size ( {S}_{10 P} )}{size ( {S}_{20 P} )} > threshold\_ 20 p\_ 10 p ) \&\& ( pure\_red \_color ) \&\& ( {ratio}_{R 20 P} > {ratio}_{B 20 P} ) ) satskew = 15 ; or equivalently k = 2 ; else satskew = 10 ; or equivalently k = 1 ;$$

If (mean luma on the image<5) and (S̅_̅{̅2̅0̅P̅}̅<0.6)
Or (mean luma on the image<10) and (ratio_{B20P}>0.7)
Or (mean luma on the image<20) and (ratio_{B20P}>0.8)
Or (mean luma on the image<30) and (ratio_{B20P}>0.9))
satskew is decreased to 5; or equivalently k is decreased by 1;
   2—Decoding an HDR picture from a coded bitstream:

FIG. 8 illustrates a block diagram of an exemplary method for decoding an HDR picture from a coded bitstream according to an embodiment of the present principle. According this embodiment, the coded bitstream has been obtained according to the coding method as described with FIG. 7.

In a step E9, an SDR picture is decoded from said coded bitstream. For example, when the coded bitstream is conformant with an HEVC Main 10 profile, the coded bitstream is decoded according to the corresponding decoding process.

In step E9, HDR parameters are also decoded from the coded bitstream. THe HDR parameters may comprise at least: luma mapping parameters allowing to derive a LUT for mapping SDR luma to HDR luma, reconstruction parameters such as the v, a, and b parameters used to derive luma values from the decoded luma samples of the SDR picture.

In a step E14, the LUT invLUT for mapping luma values to luminance values is derived from the luma mapping parameters.

According to the present embodiment, in a step E10, an index representative of a predetermined post-processing colour correction function bₚ_{_}_{det} among a set of predetermined post-processing colour correction functions bₚ^{set} is decoded.

According to one variant, the set of predetermined post-processing colour correction functions bₚ^{set} is predefined at the decoder.

In a step E12, the post-processing colour correction function bₚ_{_}_{det} is selected according to the decoded index idx.

In a step E13, the HDR picture is then reconstructed from the decoded SRD picture and using the selected post-processing colour correction function bₚ_{_}_{det}. Such reconstruction step E13 is performed similarly as the reconstruction process described in FIG. 4.

According to another variant, in a step E11, the set of predetermined post-processing colour correction functions bₚ^{set} is decoded from the coded bitstream.

FIG. 9 illustrates a block diagram of an exemplary method for decoding an HDR picture from a coded bitstream according to another embodiment of the present principle. According this embodiment, the coded bitstream has been obtained according to the coding method as described with FIG. 5.

According to this embodiment, the coded bitstream comprises a set of pivot points representative of an adjustment function f_{adj} used to adjust a post-processing colour correction function bₚ_{_}_{default} known at the decoder.

In step E9, the SDR picture and HDR parameters are decoded from the coded bitstream.

In step E14, the LUT invLUT for mapping luma values of SDR picture to luminance values of HDR picture is derived from the luma mapping parameters.

According to the present embodiment, in step E10, the pivot points representative of the adjustment function f_{adj} are decoded.

In step E12, a post-processing colour correction function bₚ_{_}_{dec} is built from the adjustment function f_{adj} and a predetermined post-processing colour correction function bₚ_{_}_{default}.

According to this embodiment, the post-processing colour correction function bₚ_{_}_{default} is selected among a set of predetermined post-processing colour correction functions bₚ_{_}_{default}^{set} wherein the post-processing colour correction function (LUT) are predefined at the decoder. For instance, one LUT is defined for each triple (container colour gamut, content colour gamut, peak luminance). The post-processing colour correction function bₚ_{_}_{default} is identified according to the content characteristics parameters coded at the picture or sequence level in the coded bitstream.

The post-processing colour correction function bₚ_{_}_{dec} is then built according to equation (eq. 2).

In step E13, the HDR picture is then reconstructed from the decoded SRD picture and using the adjusted post-processing colour correction function bₚ_{_}_{dec}. Such reconstruction step E13 is performed similarly as the reconstruction process described in FIG. 4.

On FIGS. 1 to 9, 12 and 13 the method steps are performed by modules, which are functional units, such modules may or not be in relation with distinguishable physical units. For example, these modules or some of them may be brought together in a unique component or circuit, or contribute to functionalities of a software. A contrario, some modules may potentially be composed of separate physical entities. The apparatus which are compatible with the disclosure are implemented using either pure hardware, for example using dedicated hardware such ASIC or FPGA or VLSI, respectively [symbol] Application Specific Integrated Circuit [symbol] , [symbol] Field-Programmable Gate Array [symbol] , [symbol] Very Large Scale Integration [symbol] , or from several integrated electronic components embedded in a device or from a blend of hardware and software components.

FIG. 11 represents an exemplary architecture of a device 110 which may be configured to implement a method described in relation with FIGS. 1-9.

Device 110 comprises following elements that are linked together by a data and address bus 111:
a microprocessor 112 (or CPU), which is, for example, a DSP (or Digital Signal Processor);
a ROM (or Read Only Memory) 113;
a RAM (or Random Access Memory) 114;
an I/O interface 115 for transmission and/or reception of data, from an application; and
a battery 116.

According to a variant, the battery 116 is external to the device. Each of these elements of FIG. 10 are well-known by those skilled in the art and won't be disclosed further. In each of mentioned memory, the word [symbol] register [symbol] used in the specification can correspond to area of small capacity (some bits) or to very large area (e.g. a whole program or large amount of received or decoded data). ROM 113 comprises at least a program and parameters. Algorithm of the methods according to the disclosure is stored in the ROM 113. When switched on, the CPU 112 uploads the program in the RAM and executes the corresponding instructions.

RAM 114 comprises, in a register, the program executed by the CPU 112 and uploaded after switch on of the device 110, input data in a register, intermediate data in different states of the method in a register, and other variables used for the execution of the method in a register.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

According to a specific embodiment of encoding or encoder, the HDR color picture is obtained from a source. For example, the source belongs to a set comprising:
a local memory (113 or 114), e.g. a video memory or a RAM (or Random Access Memory), a flash memory, a ROM (or Read Only Memory), a hard disk;
a storage interface, e.g. an interface with a mass storage, a RAM, a flash memory, a ROM, an optical disc or a magnetic support;
a communication interface (115), e.g. a wireline interface (for example a bus interface, a wide area network interface, a local area network interface) or a wireless interface (such as a IEEE 802.11 interface or a Bluetooth® interface); and
a picture capturing circuit (e.g. a sensor such as, for example, a CCD (or Charge-Coupled Device) or CMOS (or Complementary Metal-Oxide-Semiconductor)).

According to different embodiments of the decoding or decoder, the HDR decoded picture is sent to a destination; specifically, the destination belongs to a set comprising:
a local memory (113 or 114), e.g. a video memory or a RAM (or Random Access Memory), a flash memory, a ROM (or Read Only Memory), a hard disk;
a storage interface, e.g. an interface with a mass storage, a RAM, a flash memory, a ROM, an optical disc or a magnetic support;
a communication interface (115), e.g. a wireline interface (for example a bus interface, a wide area network interface, a local area network interface) or a wireless interface (such as a IEEE 802.11 interface or a Bluetooth® interface); and
a display.

According to different embodiments of encoding or encoder, the coded bitstream is sent to a destination. As an example, the coded bitstream is stored in a local or remote memory, e.g. a video memory (114) or a RAM (114), a hard disk (113). In a variant, the bitstream is sent to a storage interface, e.g. an interface with a mass storage, a flash memory, ROM, an optical disc or a magnetic support and/or transmitted over a communication interface (115), e.g. an interface to a point to point link, a communication bus, a point to multipoint link or a broadcast network.

According to different embodiments of decoding or decoder, the bitstream is obtained from a source. Exemplarily, the bitstream is read from a local memory, e.g. a video memory (114), a RAM (114), a ROM (113), a flash memory (113) or a hard disk (113). In a variant, the bitstream is received from a storage interface, e.g. an interface with a mass storage, a RAM, a ROM, a flash memory, an optical disc or a magnetic support and/or received from a communication interface (115), e.g. an interface to a point to point link, a bus, a point to multipoint link or a broadcast network.

According to different embodiments, device 110 being configured to implement an encoding method described in relation with FIG. 1, 5 or 7, belongs to a set comprising:
a mobile device;
a communication device;
a game device;
a tablet (or tablet computer);
a laptop;
a still picture camera;
a video camera;
an encoding chip;
a still picture server; and
a video server (e.g. a broadcast server, a video-on-demand server or a web server).

According to different embodiments, device 110 being configured to implement a decoding method described in relation with FIG. 2, 8 or 9, belongs to a set comprising:
a mobile device;
a communication device;
a game device;
a set top box;
a TV set;
a tablet (or tablet computer);
a laptop;
a display and
a decoding chip.

Implementations of the various processes and features described herein may be embodied in a variety of different equipment or applications. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and any other device for processing a picture or a video or other communication devices. As should be clear, the equipment may be mobile and even installed in a mobile vehicle.

Additionally, the methods may be implemented by instructions being performed by a processor, and such instructions (and/or data values produced by an implementation) may be stored on a computer readable storage medium. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

The instructions may form an application program tangibly embodied on a processor-readable medium.

Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for coding at least one high dynamic range picture into a coded bitstream, said method comprising:
selecting a first predetermined post-processing colour correction function bₚ_{_}_{det} among a first set of predetermined post-processing colour correction functions bₚ^{set}, according to at least one parameter computed from said at least one high dynamic range picture,
determining a pre-processing colour correction function b₀ from said selected first predetermined post-processing colour correction function bₚ_{_}_{det},
decomposing said high dynamic range picture into a standard dynamic range picture, using said pre-processing colour correction function b₀,
selecting a second predetermined post-processing colour correction function bₚ_{_}_{default} among a second set of predetermined post-processing colour correction functions b^{set}ₚ_{_}_{default} which are known to a decoder, according to characteristics of said high dynamic range picture,
determining an adjustment function f_{adj} used to adjust said selected predetermined colour correction function bₚ_{_}_{default} into a third post-processing colour correction function bₚ_{_}_{dec} and defined such that said third post-processing colour correction function bₚ_{_}_{dec} maps as much as possible the selected second predetermined colour correction function b_{P}_{_}_{default} to the selected first predetermined post-processing colour correction function bₚ_{_}_{det} by minimizing their difference |bₚ_{_}_{det}−bₚ_{_}_{dec}|,
coding into said coded bitstream said standard dynamic range picture, said characteristics of the high dynamic range picture, and said adjustment function f_{adj}.

2. The method for coding according to claim 1, wherein said at least one parameter computed from said at least one high dynamic range picture is a saturation skew parameter.

3. The method for coding at least one high dynamic range picture into a coded bitstream according to claim 1, wherein said adjustment function f_{adj} is modeled using a set of pivot points representative of said adjustment function f_{adj}, and wherein, for the coding of said adjustment function f_{adj}, only said set of pivot points are coded.

4. A method for decoding at least one high dynamic range picture from a coded bitstream, wherein said method comprises:
decoding from said coded bitstream a standard dynamic range picture from said coded bitstream and a set of pivot points representative of an adjustment function f_{adj},
building a post-processing colour correction function bₚ_{_}_{dec} from said adjustment function f_{adj} and from a predetermined post-processing colour correction function bₚ_{_}_{default},
reconstructing said high dynamic range picture from said decoded standard dynamic range picture and said built post-processing colour correction function bₚ_{_}_{dec}.

5. The method for decoding at least one high dynamic range picture from a coded bitstream according to claim 4, wherein said method further comprises:
selecting said predetermined post-processing colour correction function bₚ_{_}_{default} among a set of predetermined post-processing colour correction function b^{set}ₚ_{_}_{default}, according to content characteristics parameters coded at the picture in the coded bitstream.

6. A method for coding at least one high dynamic range picture into a coded bitstream, said method comprising:
selecting a predetermined post-processing colour correction function bₚ_{_}_{det} among a set of predetermined post-processing colour correction functions bₚ^{set}, according to at least one parameter computed from said at least one high dynamic range picture,
determining a pre-processing colour correction function b₀ from said selected predetermined post-processing colour correction function bₚ_{_}_{det},
decomposing said high dynamic range picture into a standard dynamic range picture, using said pre-processing colour correction function b₀,
coding into said coded bitstream said standard dynamic range picture and the at least one parameter representative of the selected predetermined post-processing colour correction function bₚ_{_}_{det}.

7. The method for coding according to claim 6, wherein said at least one parameter computed from said at least one high dynamic range picture is a saturation skew parameter.

8. A method for decoding at least one high dynamic range picture from a coded bitstream, said method comprising:
decoding from said coded bitstream a standard dynamic range picture from said coded bitstream and at least one parameter representative of a predetermined post-processing colour correction function bₚ_{_}_{det};
reconstructing said high dynamic range picture from said decoded standard dynamic range picture and said predetermined post-processing colour correction function bₚ_{_}_{det}.

9. The method for decoding according to claim 8, wherein said at least one parameter is a saturation skew parameter.

10. The method for decoding at least one high dynamic range picture from a coded bitstream according to claim 8, further comprising:
selecting said predetermined post-processing colour correction function bₚ_{_}_{det} among a set of predetermined post-processing colour correction functions bₚ^{set}, according to said at least one decoded parameter.

11. An apparatus for coding at least one high dynamic range picture into a coded bitstream, comprising at least one processor configured for:
selecting a first predetermined post-processing colour correction function bₚ_{_}_{det} among a first set of predetermined post-processing colour correction functions bₚ^{set}, according to at least one parameter computed from said at least one high dynamic range picture,
determining a pre-processing colour correction function b₀ from said selected first predetermined post-processing colour correction function bₚ_{_}_{det},
decomposing said high dynamic range picture into a standard dynamic range picture, using said pre-processing colour correction function b₀,
selecting a second predetermined post-processing colour correction function bₚ_{_}_{default} among a second set of predetermined post-processing colour correction function b^{set}ₚ_{_}_{default} which are known to a decoder, according to characteristics of the high dynamic range picture,
determining an adjustment function f_{adj} used to adjust said selected second predetermined colour correction function bₚ_{_}_{default} into a third post-processing colour correction function bₚ_{_}_{dec} and defined such that said third post-processing colour correction function bₚ_{_}_{dec} maps as much as possible the second selected predetermined colour correction function b_{P}_{_}_{default} to the selected first predetermined post-processing colour correction function bₚ_{_}_{det} by minimizing their difference |bₚ_{_}_{det}−bₚ_{_}_{dec}|,
coding into said coded bitstream said standard dynamic range picture and said adjustment function f_{adj}.

12. The apparatus for coding according to claim 11, wherein said at least one parameter computed from said at least one high dynamic range picture is a saturation skew parameter.

13. An apparatus for decoding at least one high dynamic range picture from a coded bitstream, comprising at least one processor configured for:
decoding from said coded bitstream a standard dynamic range picture from said coded bitstream and a set of pivot points representative of an adjustment function f_{adj},
building a post-processing colour correction function bₚ_{_}_{dec} from said adjustment function f_{adj} and from a predetermined post-processing colour correction function bₚ_{_}_{default},
reconstructing said high dynamic range picture from said decoded standard dynamic range picture and said built post-processing colour correction function bₚ_{_}_{dec}.

14. The apparatus for decoding at least one high dynamic range picture from a coded bitstream according to claim 13, wherein said at least one processor is further configured for:
selecting said predetermined post-processing colour correction function bₚ_{_}_{default} among a set of predetermined post-processing colour correction function b^{set}ₚ_{_}_{default}, according to content characteristics parameters coded at the picture in the coded bitstream.

15. An apparatus for coding at least one high dynamic range picture into a coded bitstream, comprising at least one processor configured for:
selecting a predetermined post-processing colour correction function bₚ_{_}_{det} among a set of predetermined post-processing colour correction functions bₚ^{set}, according to at least one parameter computed from said at least one high dynamic range picture,
determining a pre-processing colour correction function b₀ from said selected predetermined post-processing colour correction function bₚ_{_}_{det},
decomposing said high dynamic range picture into a standard dynamic range picture, using said pre-processing colour correction function b₀,
coding into said coded bitstream said standard dynamic range picture and the at least one parameter representative of the selected predetermined post-processing colour correction function bₚ_{_}_{det}.

16. The apparatus for coding according to claim 15, wherein said at least one parameter computed from said at least one high dynamic range picture is a saturation skew parameter.

17. An apparatus for decoding at least one high dynamic range picture from a coded bitstream, comprising at least one processor configured for:
decoding from said coded bitstream a standard dynamic range picture and at least one parameter representative of a predetermined post-processing colour correction function bₚ_{_}_{det},
reconstructing said high dynamic range picture from said decoded standard dynamic range picture and said predetermined post-processing colour correction function bₚ_{_}_{det}.

18. The apparatus for decoding at least one high dynamic range picture from a coded bitstream according to claim 17, wherein said at least one processor is further configured for:
selecting said predetermined post-processing colour correction function bₚ_{_}_{det} among a set of predetermined post-processing colour correction functions bₚ^{set}, according to said at least one decoded parameter.

19. A computer program comprising software code instructions for performing the method according to claim 1, when the computer program is executed by a processor.

20. An electronic device incorporating the apparatus for coding according to claim 11.

21. An electronic device incorporating the apparatus for coding according to claim 12.

22. An electronic device incorporating the apparatus for coding according to claim 15.

23. An electronic device incorporating the apparatus for coding according to claim 16.

24. The electronic device according to claim 20, selected from the group consisting of a mobile device, a communication device, a game device, a tablet, a laptop, a still picture camera, a video camera, an encoding chip, a still picture server and a video server.

25. An electronic device incorporating the apparatus for decoding according to claim 13.

26. An electronic device incorporating the apparatus for decoding according to claim 14.

27. An electronic device incorporating the apparatus for decoding according to claim 17.

28. An electronic device incorporating the apparatus for decoding according to claim 18.

29. The electronic device according to claim 25, selected from the group consisting of a mobile device, a communication device, a game device, a set top box, a TV set, a tablet, a laptop, a display and a decoding chip.
